(19) United States
(12) Patent Application Publication
(10) Pub. No.: US 2006/0062251 A1
(43) Pub. Date: Mar. 23, 2006

(54) Session data and setting method thereof in a sychronous wireless communication system

(75) Inventors: Yong-Suk Lim, Seoul (KR); Oh-Ae Kwon, Gunpo (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/234,662

(22) Filed: Sep. 22, 2005

(30) Foreign Application Priority Data
Sep. 22, 2004 (KR) 10-2004-0076086

(51) Int. Cl. H04J 1/16; H04Q 7/00; H04Q 7/24; H04J 3/22; H04L 12/26; H04J 3/16

(52) U.S. Cl. 370/468; 370/328; 370/338; 370/252

(57) ABSTRACT

In session data and a method for establishing a session in a synchronous wireless communication system in accordance with the present invention, by additionally defining a maximum bit rate parameter of the EVRC such that the maximum rate can be varied according to circumstances and conditions of a wireless network, the capacity of the wireless network is expanded and therefore more efficiently used. Services can be flexibly implemented according to the circumstances and conditions of the wireless network by using the maximum bit rate parameter for increasing or decreasing the bandwidth of the wireless network.

### CROSS-REFERENCE TO RELATED APPLICATIONS

This application claims the benefit of the Korean Patent Application No. 76086/2004, filed on Sep. 22, 2004, which is hereby incorporated by reference as if fully set forth herein.

### FIELD OF THE INVENTION

The present invention relates to a session of a synchronous wireless communication system, and more particularly, to a method for establishing session data using a maximum bit rate parameter for communications networks in a synchronous wireless communication system.

### BACKGROUND OF THE INVENTION

A Push to Talk (“PTT”) service refers to an instant voice communication service allowing communication with another party without dialing or without performing a call connection, and is a voice transmission service using Session Initiation Protocol (“SIP”).

To implement a PTT service, two terminals or a terminal and a server establish an SIP session through an SIP message, encode the voice traffic using an enhanced variable rate coder (EVRC), and transmit the encoded voice using Real-time Transport Protocol (“RTP”). A server may be a base station for sending wireless communications to a number of terminals and receiving wireless communications from a number of terminals.

The SIP message includes the Session Description Protocol (“SDP”) used for the definition of voice characteristics and negotiation. The SDP includes codecs used to code and decode the voice traffic, characteristics of the codecs, and other various parameters necessary for transmitting voice traffic.

After the session is established between two terminals or between a terminal and a server, the terminals participating in the PTT service can transmit or receive voice traffic with each other using identical methods for voice transmission to the characteristics defined in the SDP.

The EVRC is a voice codec used mainly in a synchronous wireless communications, in which wireless communication providers transmit voice traffic using different data transmission rates (bit rates) according to conditions of each wireless network or methods of offering services. If the wireless network is not in good condition, the voice traffic is transmitted at a low data transmission rate, and if the wireless network is in good condition, the voice traffic is transmitted at a high data transmission rate.

When a session is established in a PTT system, the session defines in the SDP that EVRC is used as a voice codec, but information on whether the EVRC uses a variable or a static bit rate, and how a maximum bit rate is to be determined presently are not defined by the SDP.

Accordingly, since the PPT system operates at a bit rate previously established between two terminals or between a terminal and a server in session connections with other, resources of the wireless network are not only wasted because the bit rate cannot be varied according to the conditions of the wireless network, but also because interworking between different networks cannot be performed.

### SUMMARY OF THE INVENTION

Therefore, an object of the present invention is to provide session data and a method for providing session data in a synchronous wireless communication system, wherein an additional EVRC parameter is defined such that the data transmission rate can be varied according to circumstances of a wireless network between two terminals or between a terminal and a server.

To achieve this and other advantages and in accordance with the purpose of the present invention, as embodied and broadly described herein, session data of a synchronous wireless communication system is provided establishing a SIP session between two terminals or between a terminal and a server wherein the session data includes a parameter defining the maximum bit rate of a voice codec.

A parameter is added to the session data of the SDP to define the maximum bit rate of a voice codec. The parameter is expressed as an equation, “a=fmtp:97 maxrate=number/variable bit rate or static bit rate”, wherein:
‘a’ defines an attribute of media;
‘fmtp’ is a format parameter;
‘97’ is a profile ID of a voice codec and a characteristic with respect to the EVRC (97); and
‘maxrate=number’ is the maximum bit rate value.

To achieve these and other advantages and in accordance with the purpose of the present invention, as embodied and broadly described herein, there is provided a method of establishing session data of a synchronous wireless communication system between two terminals or between a terminal and a server, comprising: transmitting an “INVITE” message including a parameter defining the maximum bit rate of a voice codec from the terminal or the server; and receiving a “200 OK” message including the parameter defining the maximum bit rate from the server or the terminal having received the “INVITE” message.

It is to be understood that both the foregoing general description and the following detailed description of the present invention are exemplary and explanatory and are intended to provide further explanation of the invention as claimed. The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a signal flowchart showing a method for setting a session by using the SDP in accordance with the present invention.

### DETAILED DESCRIPTION OF THE PREFERRED EMBODIMENTS

Hereinafter, reference will now be made in detail to the preferred embodiments of session data and a method for establishing a session in a synchronous wireless communication system in accordance with present invention, examples of which are illustrated in the accompanying drawings.

Table 1 shows general SDP information that is included in an SIP message of a PTT service system.

TABLE 1

| | Parameter | |
|---|---|---|
| SDP parameter | name | Description |
| v = 0 | Version | SDP version |
| | name | |
| c = IN IP4 x.x.x.x | Connect | Sender's IP address for |
| | | RTP/RTCP |
| m = audio port#RTP/AVP 97 | Media | Port# :sender's RTP port |
| | | number 97 : EVRC profile ID |
| a = rtpmap:97 EVRC/8000 | Attribute | Sampling rate of EVRC codec |
| | | is 8000 |
| a = ptime:160 | Attribute | Voice data corresponding to |
| | | 160 msec included in RTP 1 |
| | | packet |
| a = sendonly | Attribute | Mode for transmission |
| | | without receipt, that is, voice |
| | | transmission is only |
| | | performed. |

The items are values that are not altered for service compatibility unless a separate negotiation occurs between a two terminals or between a terminal and a server. However, the IP address or the port number may not be changed.

With reference to Table 1, 160 msec of voice data is encoded/decoded using the EVRC and is included in an RTP 1 packet. However, because information is not present relating to whether a variable rate or a static rate is used for the EVRC encoding, or what the maximum bit rate for encoding/decoding is, the EVRC codec uses bit rate for the previous encoding/decoding.

In the present invention, further coordination is possible by adding a parameter defining the maximum bit rate and whether the bit rate is static or variable of the EVRC to the SDP,

Various SDP parameters such as v, c, m and a can be used. The Format Parameter ‘fmtp’ can be used among attributes of ‘a’. At this time, ‘fmtp’ is not interpreted in the SDP level, and in relation to specific media, ‘fmtp’ can be used by defining parameters.
a=fmtp:97 (Equation 1)

Equation 1 is a parameter defined by the present invention expressing the maximum bit rate and determining whether a variable bit rate or a static bit rate is used. Equation 1, ‘a=fmtp’, defines ‘a’, an attribute of media and a profile ID for the EVRC, ‘97’. The profile of the EVRC further includes information whether voice traffic is variably coded using less than the maximum bit rate or statically coded using the maximum bit rate, and the value of maximum bit rate.

In the present invention, the profile ID of EVRC is ‘97’, however, the profile ID may have any value between 96 and 127.
a=fmtp:97 maxrate=3/variable (Equation 2)

Equation 2 is one example showing the maximum bit rate and whether a bit rate is variable or static. The maximum bit rate, ‘maxrate’, may have a value of 1, 2, 3, or 4 corresponding to the maximum bit rate for the EVRC as shown in Table 2 below. The bit rate may variable or static depending whether ‘variable’ or ‘static’ follows the slash character.

TABLE 2

| ‘maxrate’ | Bit Rate |
|---|---|
| 1 | 1/8 rate EVRC |
| 2 | 1/4 rate EVRC |
| 3 | 1/2 rate EVRC (Half rate) |
| 4 | 1/1 rate EVRC (Full rate) |

The EVRC currently used in Code Division Multiple Access (CDMA) terminals can generate voice data having one of four bit rates as shown in Table 2. The maximum rate is set as ‘4’ or full rate or ‘3’ half rate according to circumstances and conditions of the wireless network. The higher the maximum bit rate, the more the data can be transmitted and the voice quality.

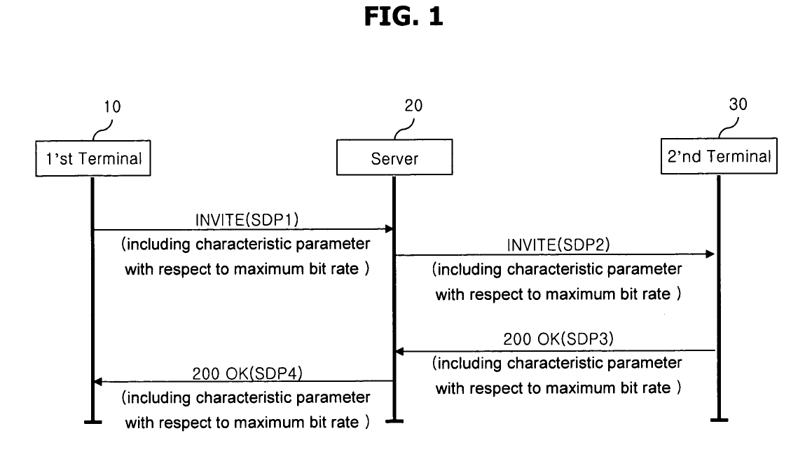

FIG. 1 is a signal flowchart showing a method for establishing a session using the SDP in accordance with the present invention. The process that a first terminal establishes the SIP a second terminal will be described as follows.

The first terminal 10 belongs to a wireless network having a maximum bit rate of ‘3’ (half rate) and the second terminal 30 belongs to a network having a maximum bit rate of ‘4’ (full rate). The first terminal 10 sends an INVITE message, SDP1, in which ‘maxtrate=3’ is sent to the PTT server 20, and the PTT server 20 sends an INVITE message, SDP2, in which ‘maxrate=4’ is sent to the second terminal 30. The PTT server 20, the first terminal 10 and the second terminal 30 can send the INVITE messages by having maximum bit rates according to the circumstances and conditions of the

The second terminal 30 establishes the maximum bit rate as 4 when encoding voice, and sends a 200 OK message, SDP3, in which ‘maxtrate=4’ is sent to the PTT server 20. The PTT 20 server sends a 200 OK message, SDP4, in which ‘maxtrate=3’ is sent to the first terminal 10.

If the transmission speed of the wireless network to which the first terminal 10 belongs is increased to the maximum bit rate of ‘4’, the PTT server 20 checks the state of the wireless network and sends the 200 OK message, SDP4, in which ‘maxrate=4’ is set even though the first terminal sends the SDP1 in which ‘maxrate=3’ is set.

When the bandwidth of the wireless network between the two terminals or the terminal and the server should be increased or decreased, the terminal can flexibly vary the maximum bit rate according to circumstances and conditions of the wireless network. If the circumstances and conditions of the wireless network improve thereby increasing the bandwidth, the maximum bit rate parameter may be increased. If the circumstances and conditions of the wireless network worsen thereby reducing the bandwidth, resources of the wireless network are utilized to the maximum extent possible by decreasing the maximum bit rate parameter.

Session data and a method for setting a session of a synchronous wireless communication system in accordance with the present invention can flexibly implement services by controlling the maximum bit rate parameter with respect to the EVRC when network terminals have different voice codec transmission rates or an increasing or decreasing a bandwidth of a wireless section of a network.

Session data and a method for establishing a session of a synchronous wireless communication system in accordance with the present invention, the capacity of a wireless network is expanded and therefore may be efficiently used by varying the maximum bit rate according to circumstances and conditions of the wireless network by adding a bit rate parameter to the SDP.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for establishing a communications session by a terminal operating in a wireless communications system, the method comprising:
sending an invitation message from the terminal wherein the invitation message comprises a parameter defining a maximum bit rate of a voice codec;
receiving a confirmation message by the terminal in response to the invitation message wherein the confirmation message comprises a retransmission of the parameter defining the maximum bit rate of the voice codec; and
transmitting voice traffic from the terminal at the maximum bit rate defined by the parameter wherein the maximum bit rate is varied according to conditions of the wireless communications system.

2. The method of claim 1, wherein the parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the maximum bit rate, and ‘status’ is either ‘variable’ or ‘static’ indicating whether or not the maximum bit rate is variable.

3. The method of claim 2, wherein ‘number’ refers to the maximum bit rate when the bit rate is variable or static.

4. A wireless communications terminal comprising:
a means for establishing a communications session between a first terminal and a second terminal wherein the means for establishing a communications session further comprises:
an invitation message sent from the first terminal wherein the invitation message comprises a parameter defining a maximum bit rate of a voice codec;
a confirmation message received by the first terminal wherein the acknowledgment message comprises the parameter defining the maximum bit rate of a voice codec; and
voice traffic transmitted at the maximum bit rate defined by the parameter wherein the maximum bit rate is varied according to the conditions of the wireless communications system.

5. The system of claim 4, wherein the parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the maximum bit rate, and ‘status’ is either ‘variable’ or ‘static’ indicating whether or not the maximum bit rate is variable.

6. The system of claim 5, wherein ‘number’ refers to the maximum bit rate when the bit rate is variable or static.

7. A method for establishing a communication session of a wireless communications system between a first terminal and a second terminal, wherein the first terminal belongs to a first network and the second terminal belongs to a second network, the method comprising:
sending a first invitation message from the first terminal wherein the first invitation message comprises a first parameter defining a first maximum bit rate of a voice codec for transmitting voice traffic from the first terminal;
receiving a second invitation message by the second terminal wherein the second invitation message comprises a second parameter defining a second maximum bit rate of the voice codec for transmitting voice traffic;
sending a first confirmation message from the second terminal wherein the first confirmation message comprises the second parameter defining the maximum bit rate of a voice codec;
receiving a second confirmation message by the first terminal wherein the second confirmation message comprises the first parameter defining the maximum bit rate of a voice codec;
transmitting voice traffic from the first terminal at the first maximum bit rate; and
receiving voice traffic by the second terminal at the second maximum bit rate.

8. The method of claim 7, wherein the first maximum bit rate is varied according to the conditions of the first network.

9. The method of claim 7, wherein second maximum bit rate is varied according to the conditions of the second network.

10. The method of claim 7, wherein the first parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the first maximum bit rate, and ‘status’ is either ‘variable’ or ‘static’ indicating whether or not the first maximum bit rate may be varied.

11. The method of claim 10, wherein ‘number’ refers to the first maximum bit rate whether the first maximum bit rate is variable or static.

12. The method of claim 7, wherein the second parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the second maximum bit rate, and ‘status’ is either ‘variable’ or ‘static’ indicating whether or not the second maximum bit rate may be varied.

13. The method of claim 12, wherein ‘number’ refers to the second maximum bit rate whether the second maximum bit rate is variable or static.

14. A wireless communications terminal comprising:
a means for establishing a communications session between a first terminal and a second terminal wherein the first terminal is in a first network and the second terminal is in a second network, and wherein the means for establishing a communications session further comprises:
a first invitation message sent from the first terminal wherein the first invitation message comprises a first parameter defining a first maximum bit rate of a voice codec for transmitting voice traffic from the first terminal;
a second invitation message received by the second terminal wherein the second invitation message comprises a second parameter defining a second maximum bit rate of the voice codec for transmitting voice traffic;
a first confirmation message sent from the second terminal wherein the first confirmation message comprises the second parameter defining the maximum bit rate of a voice codec;
a second confirmation message received by the first terminal wherein the second confirmation message comprises the first parameter defining the maximum bit rate of a voice codec;
transmitting voice traffic from the first terminal at the first maximum bit rate; and
receiving, voice traffic by the second terminal at the second maximum bit rate.

15. The terminal of claim 14, wherein the first maximum bit rate is varied according to the conditions of the first network.

16. The terminal of claim 14, wherein second maximum bit rate is varied according to the conditions of the second network.

17. The terminal of claim 14, wherein the first parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the first maximum bit rate, and ‘status’ is either ‘variable’ or ‘static’ indicating whether or not the first maximum bit rate may be varied.

18. The terminal of claim 17, wherein ‘number’ refers to the first maximum bit rate whether the first maximum bit rate is variable or static.

19. The terminal of claim 14, wherein the second parameter comprises the equation
a=fmtp:97 maxrate=number/status
wherein ‘a’ is an attribute of media, ‘fmtp’ is a format parameter, ‘97’ is a profile identification of the voice codec, ‘maxrate=number’ is a value for the second maximum bit rate, and ‘status’ is either ‘variable’ or ‘static’ indicating whether or not the second maximum bit rate may be varied.

20. The terminal of claim 19, wherein ‘number’ refers to the second maximum bit rate whether the second maximum bit rate is variable or static.
